(19) United States
(12) Patent Application Publication
(10) Pub. No.: US 2020/0051492 A1
(43) Pub. Date: Feb. 13, 2020

(54) DRIVING METHOD OF DISPLAY APPARATUS

(71) Applicant: Au Optronics Corporation, Hsinchu (TW)

(72) Inventors: Shin-Shueh Chen, Hsinchu County (TW); Pin-Miao Liu, Hsinchu County (TW); Yi-Wei Chen, Hsinchu County (TW)

(73) Assignee: Au Optronics Corporation, Hsinchu (TW)

(21) Appl. No.: 16/528,677

(22) Filed: Aug. 1, 2019

Related U.S. Application Data
(60) Provisional application No. 62/717,260, filed on Aug. 10, 2018.

(30) Foreign Application Priority Data
Feb. 15, 2019 (TW) 108105134

(51) Int. Cl. G09G 3/32

(52) U.S. Cl. CPC G09G 3/32; G09G 2360/144; G09G 2330/023; G09G 2320/0233; G09G 2320/0626; G09G 2320/0247

(57) ABSTRACT

A driving method of a display apparatus is provided, wherein the display apparatus includes a plurality of pixels. The driving method includes the following steps: obtaining a first gray level and a second gray level corresponding to a first pixel and a second pixel among the pixels based on display data, wherein the first gray level and the second gray level are different; determining a first frequency and a second frequency according to the first gray level and the second gray level; and driving the first pixel to operate in the first frequency and driving the second pixel to operate in the second frequency at the same time, wherein the first frequency and the second frequency are different.

### CROSS-REFERENCE TO RELATED APPLICATION

This application claims the priority benefits of U.S. provisional application Ser. No. 62/717,260, filed on Aug. 10, 2018, and Taiwan application serial no. 108105134, filed on Feb. 15, 2019. The entirety of each of the above-mentioned patent applications is hereby incorporated by reference herein and made a part of this specification.

### BACKGROUND

### Technical Field

The present disclosure relates to a display apparatus, and more particularly to a driving method of a display apparatus.

### Description of Related Art

The existing display apparatus can achieve power saving by reducing flicker frequency when displaying a static image or an image with less or slower changes, which is because the lower the refresh rate of the pixels, the less power is consumed. At present, the commonly used power-saving technology is to reduce the frequency of all pixels at a time, so that all pixels operate in the low frequency mode. However, in that case, as the refresh rate decreases, the flicker phenomenon of image will become more obvious, resulting in a decline in image quality.

Therefore, how to achieve power saving under the premise of maintaining image quality has become a problem to be solved in the development of display apparatus.

### SUMMARY

The disclosure provides a driving method of a display apparatus, which can individually adjust the frequency of pixels, and provides good image quality and better power-saving effect.

In a driving method of a display apparatus of the present disclosure, the display apparatus includes a plurality of pixels. The driving method includes the steps of: obtaining a first gray level and a second gray level corresponding to a first pixel and a second pixel among the pixels based on display data, wherein the first gray level and the second gray level are different; determining a first frequency and a second frequency according to the first gray level and the second gray level; and driving the first pixel to operate at the first frequency and simultaneously driving the second pixel to operate at the second frequency, wherein the first frequency is different from the second frequency.

In an embodiment of the present disclosure, in the above driving method, the step of determining the first frequency and the second frequency according to the first gray level and the second gray level includes: comparing the first gray level and the second gray level with a reference gray level range to determine the first frequency and the second frequency, wherein when the first gray level falls outside the reference gray level range, the first frequency is determined as a low frequency mode, and when the second gray level falls within the reference gray level range, the second frequency is determined as a high frequency mode, and the first frequency is smaller than the second frequency.

In an embodiment of the disclosure, in the driving method, the reference gray level range is a continuous gray level range, wherein the width of the reference gray level range is related to the first frequency.

In an embodiment of the present disclosure, in the driving method, the step of determining the first frequency and the second frequency according to the first gray level and the second gray level further includes: determining the first frequency or the second frequency according to the color of the first pixel and the second pixel.

In an embodiment of the present disclosure, in the driving method, the step of determining the first frequency or the second frequency according to the color of the first pixel and the second pixel includes: obtaining a third gray level of a third pixel among the pixels according to the display data, wherein when the third gray level is the same as the first gray level but the color of the third pixel is different from the first pixel, the third pixel operates at a third frequency and the third frequency is different from the first frequency.

In an embodiment of the present disclosure, in the driving method, the step of determining the first frequency and the second frequency according to the first gray level and the second gray level further includes: determining the first frequency or the second frequency according to the brightness of the first pixel and the second pixel.

In an embodiment of the present disclosure, in the driving method, the step of determining the first frequency or the second frequency according to the brightness of the first pixel and the second pixel includes: obtaining a fourth gray level of a fourth pixel among the pixels according to the display data, wherein the first pixel, the second pixel, and the fourth pixel have the same color, but the first gray level, the second gray level and the fourth gray level are different from each other, the fourth pixel operates at the fourth frequency, and the first frequency, the second frequency, and the fourth frequency are also different from each other.

In an embodiment of the present disclosure, in the driving method, the step of determining the first frequency and the second frequency according to the magnitude of the first gray level and the second gray level further includes: generating an ambient light sensing signal through an ambient light sensor; and adjusting the first frequency or the second frequency according to the ambient light sensing signal.

In an embodiment of the present disclosure, in the driving method, the step of adjusting the first frequency or the second frequency according to the ambient light sensing signal further includes: obtaining a first ambient light brightness and a second ambient light brightness according to the ambient light sensing signal, wherein when the second ambient light brightness is greater than the first ambient light brightness, the first frequency or the second frequency is decreased.

In an embodiment of the disclosure, in the driving method described above, each of the pixels includes a light-emitting diode.

Based on the above, the driving method of the display apparatus of the present disclosure can select the frequency of the pixel based on the gray level of the pixel. When the gray level of the first pixel is different from the second pixel, the first pixel may be driven to operate at the first frequency, and the second pixel may be driven to operate at the second frequency, the first frequency is different from the second frequency. In this manner, the power consumption of the display apparatus is effectively adjusted.

In order to make the aforementioned features and advantages of the disclosure more comprehensible, embodiments accompanying figures are described in detail below.

### BRIEF DESCRIPTION OF THE DRAWINGS

FIG. 1 is a schematic view of a display apparatus according to an embodiment of the present disclosure.

FIG. 2 is a flow chart of a driving method of a display apparatus according to an embodiment of the present disclosure.

FIG. 3 is a schematic curve diagram showing a relationship between a gray level and a flicker value acceptable to the human eye of a display apparatus.

FIG. 4 is a schematic view of a display apparatus according to another embodiment of the present disclosure.

### DESCRIPTION OF THE EMBODIMENTS

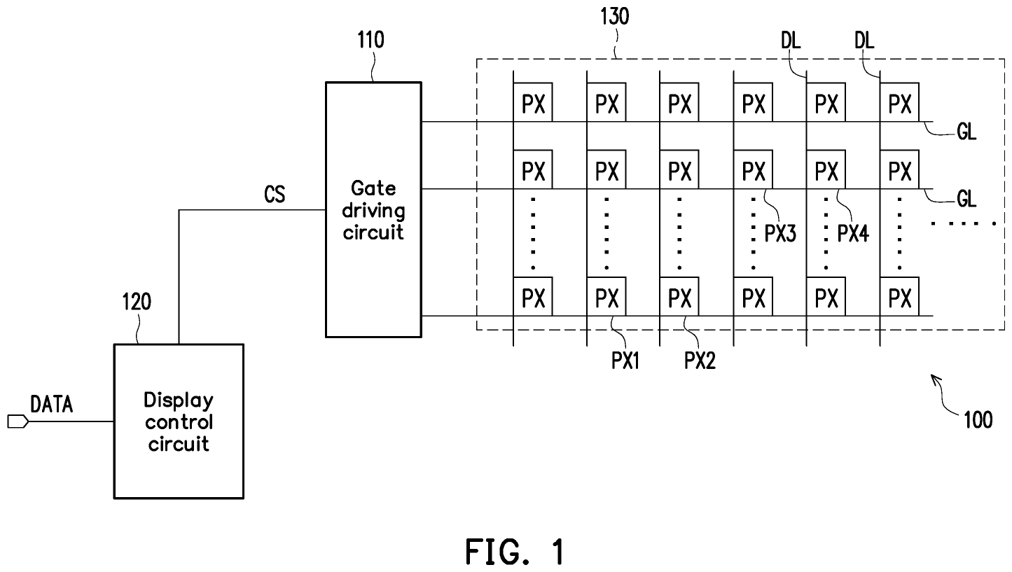

FIG. 1 is a schematic view of a display apparatus according to an embodiment of the present disclosure. Referring to FIG. 1, a display apparatus 100 includes a plurality of pixels PX, and the pixels PX are arranged in a matrix to form a pixel array 130. The display apparatus 100 at least further includes a plurality of gate lines GL, a plurality of data lines DL, a gate driving circuit 110, and a display control circuit 120. These pixels PX are disposed at the intersection of the data lines DL and the gate lines GL to control the operation of the pixels PX through the corresponding gate lines GL and the data lines DL. The display control circuit 120 receives display data DATA and is electrically connected to the gate driving circuit 110 to provide a control signal CS to the gate driving circuit 110. The gate driving circuit 110 is electrically connected to the pixels PX through the gate lines GL to drive the pixels PX according to the control signal CS. The display control circuit 120 can be implemented by the means by a chip or a circuit design, and the disclosure is not limited thereto.

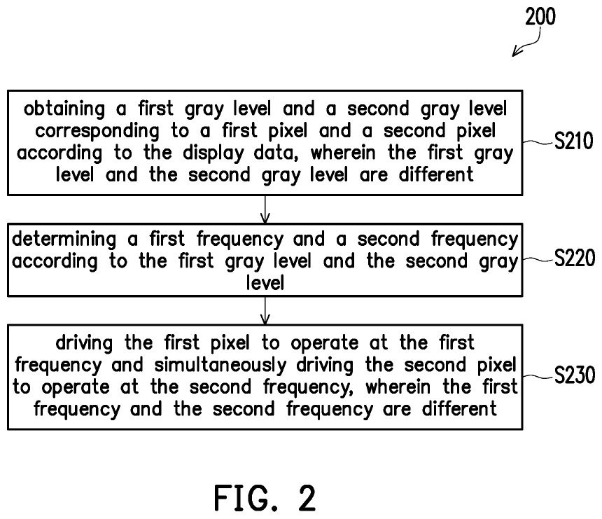

FIG. 2 is a flow chart of a driving method of a display apparatus according to an embodiment of the present disclosure. A driving method 200 can be applied to the display apparatus 100 of FIG. 1, and an embodiment of the driving method 200 will be specifically described below with reference to elements of the display apparatus 100.

In step S210, the display control circuit 120 can obtain gray levels corresponding to the pixels PX according to the display data DATA, for example, a first gray level corresponding to the first pixel PX1 and a second gray level corresponding to the second pixel PX2, wherein the first gray level and the second gray level may be different. Next, in step S220, the display control circuit 120 determines a first frequency and a second frequency according to the first gray level and the second gray level, and correspondingly generates a first control signal for the first pixel PX1 and a second control signal for the second pixel PX2. Next, in step S230, the gate driving circuit 110 drives the first pixel PX1 to operate at the first frequency according to the first control signal, and simultaneously drives the second pixel PX2 to operate at the second frequency according to the second control signal, wherein the first frequency and the second frequency may be different. The control signal CS in FIG. 1 includes the first control signal and the second control signal.

The implementation will be described in more detail below.

In this embodiment, the pixels PX may be monochromatic sub-pixels. The plurality of sub-pixels may constitute one display pixel of the resolution of the display apparatus 100. The first pixel PX1 is, for example, a red sub-pixel, the second pixel PX2 is, for example, a green sub-pixel, and the like. In other embodiments, the pixel PX may also be a display pixel, and the disclosure provides no limitation thereto. The display apparatus 100 may be a light-emitting diode (LED) panel, such as a Micro-LED panel or a Mini-LED panel, and each pixel PX has a light-emitting diode to emit monochromatic light. However, the present disclosure provides no limitation to the type of display apparatus. In other embodiments, the display apparatus 100 may also be a liquid crystal panel or other types of display apparatus.

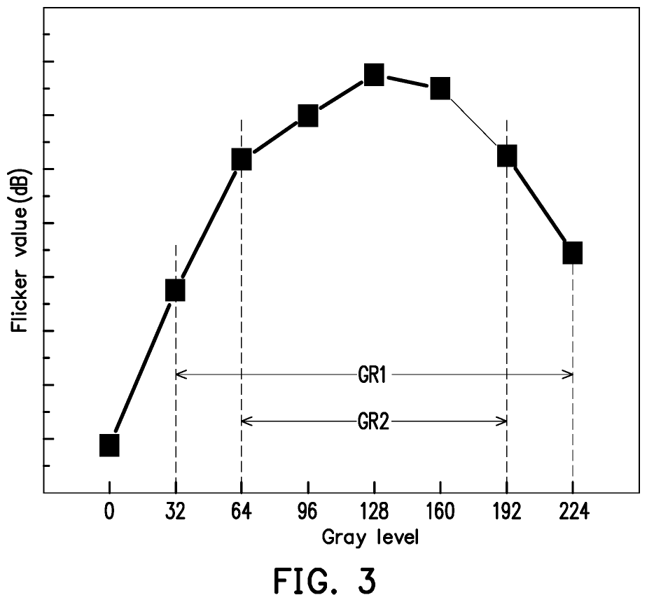

FIG. 3 is a schematic curve diagram showing a relationship between a gray level and an acceptable flicker value for the human eye of a display apparatus. The human eye has different flicker value tolerances for images with different gray levels, and a curve 310 of FIG. 3 is a variation curve showing that the acceptable flicker value for human eye is changed along with the gray level. Generally speaking, when the gray level is in the middle, the human eye is sensitive to the flicker phenomenon of the image, and it is necessary to increase the refresh rate of the pixels to avoid visual interference that makes the viewer uncomfortable. When the gray level is lower or closer to the edge, the human eye is less sensitive to the flickering of a bright image or a dark image, so the pixel with lower refresh rate is acceptable for the human eye.

Referring to FIG. 1 and FIG. 2 together with FIG. 3, in the embodiment, the display apparatus 100 can individually drive the pixels PX to operate at different frequencies. The display apparatus 100 can drive a pixel within an intermediate gray level range to operate in a high frequency mode to maintain image quality. The high frequency mode is, for example, a range of more than 30 Hz. On the other hand, the display apparatus 100 can simultaneously drive a pixel having a low gray level to operate in a low frequency mode (in some embodiments, a pixel with a high gray level may be driven to operate in the low frequency mode), which can reduce the power consumption without affecting the visual effect. The low frequency mode is, for example, a range of more than 0 Hz to less than or equal to 30 Hz, because the lower the refresh rate of the pixel, the less power is consumed. As a result, the display apparatus 100 is different from other existing display apparatuses. When a conventional display apparatus presents a static image, power is saved by reducing the frequency of all pixels. The display apparatus 100 of the embodiment can select a frequency according to the gray level of an individual pixel, that is, the operation frequency of the pixel of the partial image can be adjusted without having to be restricted to the static image, such that the application range of the power-saving mode is more flexible and broader and thus a better power-saving effect can be achieved.

Taking the reference gray level range GR1 of FIG. 3 as an example, the reference gray level range GR1 is a continuous gray level range, for example, which is a gray level range of larger than 32 and less than 224 (but not limited thereto). The display control circuit 120 may compare the first gray level and the second gray level with the reference gray level range GR1 to determine the first frequency and the second frequency. When the first gray level falls outside the reference gray level range GR1, that is, the first gray level is smaller than or equal to 32 or larger than or equal to 224, the first frequency is determined as the low frequency mode. The first pixel PX1 is selected to operate in a range of larger than or equal to 10 Hz (Hertz) and smaller than 15 Hz, for example, 10 Hz. When the second gray level falls within the reference gray level range GR1, that is, the second gray level is larger than 32 or smaller than 224, the second frequency is determined as the high frequency mode, and the second frequency is larger than the first frequency. The second pixel PX2 is, for example, selected to operate at 60 Hz.

In another embodiment, taking the reference gray level range GR2 of FIG. 3 as an example, the reference gray level range GR2 is a gray level range of larger than 64 and smaller than 192. When the first gray level falls outside the reference gray level range GR2, the first frequency is determined to be in a range of larger than or equal to 15 Hz (Hertz) and smaller than or equal to 30 Hz. When the second gray level falls within the reference gray level range GR2, the second frequency is set to be larger than 30 Hz or more, for example, still 60 Hz.

Specifically, the reference gray level range may be related to the range of the low frequency mode, that is, the width of the reference gray level range is related to the first frequency. Specifically, when the first frequency is set higher, the corresponding reference gray level range may be smaller, and the gray level range comply with the low frequency mode becomes larger. When the first frequency is set lower, the power-saving effect is better, but the reference gray level range may be larger, such that the gray level range complying with the low frequency mode becomes smaller. However, the present disclosure provides no limitation to the range of low frequency mode and high frequency mode.

In an embodiment, one display pixel includes a red pixel, a green pixel, and a blue pixel. If the display control circuit 120 determines that the gray level of the red pixel falls within the reference gray level range GR2, the gray levels of the green pixel and the blue pixel both fall outside the reference gray level range GR2, and the control signal CS provided by the display control circuit 120 allows the red pixel to continue operating at 60 Hz, but the operating frequency of the green pixel and the blue pixel is reduced such that the green pixel and the blue pixel operate at 15 Hz.

In another embodiment, the display control circuit 120 determines the first frequency or the second frequency according to the color of the first pixel PX1 and the second pixel PX2 other than according to the first gray level and the second gray level.

For example, the display control circuit 120 obtains a third gray level of a third pixel PX3 among the pixels PX according to the display data DATA, the third gray level and the first gray level are the same, but the color of the first pixel PX1 is different from that of the third pixel PX3. For example, the first pixel PX1 is a red pixel and the third pixel PX3 is a blue pixel, thus the third pixel PX3 is driven to operate at a third frequency and the third frequency is different from the first frequency. The display control circuit 120 may compare the third gray level with the reference gray level range. Since the third gray level is the same as the first gray level, the third frequency may be determined as the low frequency mode like the first frequency and is different from the second frequency. However, due to the difference in color, the first frequency may be 15 Hz and the third frequency may be 10 Hz. In other embodiments, the display control circuit 120 may also use different reference gray level ranges according to different colors of the pixels, the present disclosure provides no limitation thereto.

In short, even pixels with the same gray level may be driven at different frequencies due to the different colors of the pixels. For example, the display control circuit 120 can make pixels with a colorless sensitive to the eye to be driven at a lower frequency.

In another embodiment, the display control circuit 120 further determines the first frequency or the second frequency according to the brightness of the first pixel PX1 and the second pixel PX2. For example, the display control circuit 120 obtains a fourth gray level of the fourth pixel PX4 among the pixels PX according to the display data DATA, and the first pixel PX1, the second pixel PX2, and the fourth pixel PX4 have the same color, for example, all blue, but the first gray level, the second gray level, and the fourth gray level are different from each other. The display control circuit 120 selects different operating frequencies according to different gray levels. The fourth pixel PX4 operates at the fourth frequency, and the first frequency, the second frequency, and the fourth frequency are also different from each other. For example, the first gray level, the second gray level, and the fourth gray level are 8, 128, and 32, respectively, and the first frequency can be set to 10 Hz, the second frequency can be set to 60 Hz and the fourth frequency is set to 15 Hz.

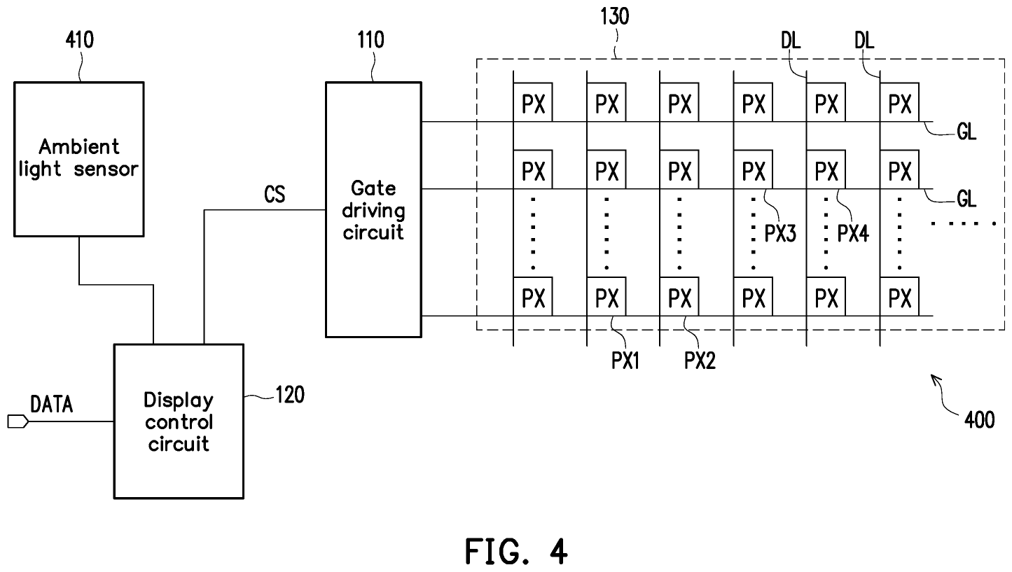

FIG. 4 is a schematic view of a display apparatus according to another embodiment of the present disclosure. A display apparatus 400 of FIG. 4 can be applied to the above-described embodiments. The configuration of the display apparatus 400 is similar to that of the display apparatus 100, but the display apparatus 400 further includes an ambient light sensor 410. The ambient light sensor 410 is electrically connected to the display control circuit 120 for detecting ambient light and generating an ambient light sensing signal. The display control circuit 120 adjusts the first frequency or the second frequency according to the ambient light sensing signal. In a state where the ambient light is strong (for example, outdoors on a sunny day), the human eye is less likely to notice the flickering of the screen, and the display apparatus 400 can further reduce the operating frequency of the pixels to save power.

In this embodiment, the display control circuit 120 sequentially obtains the first ambient light brightness and the second ambient light brightness according to the ambient light sensing signal. When the ambient light sensor 410 detects the first ambient light brightness, the first pixel PX1 operates at the first frequency and the second pixel PX2 operates at the second frequency. When the ambient light sensor 410 detects the second ambient light brightness and the second ambient light brightness is greater than the first ambient light brightness, the display control circuit 120 decreases the first frequency or the second frequency. That is, when the ambient light is bright, the display control circuit 120 can correspondingly reduce the operating frequency of the pixel, for example, reducing the first frequency of the low frequency mode from 15 Hz to 10 Hz.

In another embodiment, the ambient light sensor 410 detects that the intensity of the ambient light is greater than a reference value, such as greater than 10,000 lux (1 m/m², lux), and the display control circuit 120 may select to decrease the magnitude of the first frequency or the second frequency to save power further.

In summary, the driving method of the present disclosure is applicable to a display apparatus, which obtains a gray level of each pixel in the image by analyzing the display data, and further adjusts the operating frequency of individual pixels according to a gray level, so the operating frequency of the pixels on the same image can be different to achieve better power-saving effect.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A driving method of a display apparatus, wherein the display apparatus comprises a plurality of pixels, the driving method comprising:
obtaining a first gray level and a second gray level corresponding to a first pixel and a second pixel among the pixels according to display data, wherein the first gray level is different from the second gray level;
determining a first frequency and a second frequency according to the first gray level and the second gray level; and
driving the first pixel to operate at the first frequency and simultaneously driving the second pixel to operate at the second frequency, wherein the first frequency is different from the second frequency.

2. The driving method according to claim 1, wherein the step of determining the first frequency and the second frequency according to the first gray level and the second gray level comprises:
comparing the first gray level and the second gray level with a reference gray level range to determine the first frequency and the second frequency, wherein, when the first gray level falls outside the reference gray level range, the first frequency is determined as a low frequency mode, and when the second gray level falls within the reference gray level range, the second frequency is determined as a high frequency mode, and the first frequency is smaller than the second frequency.

3. The driving method according to claim 2, wherein the reference gray level range is a continuous gray level range, wherein the width of the reference gray level range is related to the first frequency.

4. The driving method according to claim 1, wherein the step of determining the first frequency and the second frequency according to the first gray level and the second gray level further comprises:
determining the first frequency or the second frequency according to colors of the first pixel and the second pixel.

5. The driving method according to claim 4, wherein the step of determining the first frequency or the second frequency according to the colors of the first pixel and the second pixel comprises:
obtaining a third gray level of a third pixel among the pixels according to the display data, wherein when the third gray level and the first gray level are the same but the color of the third pixel is different from that of the first pixel, the third pixel operates at a third frequency, and the third frequency is different from the first frequency.

6. The driving method according to claim 1, wherein the step of determining the first frequency and the second frequency according to the first gray level and the gray level comprises:
determining the first frequency or the second frequency according to brightness of the first pixel and the second pixel.

7. The driving method according to claim 6, wherein the step of determining the first frequency or the second frequency according to the brightness of the first pixel and the second pixel comprises:
obtaining a fourth gray level of a fourth pixel among the pixels according to the display data, wherein the first pixel, the second pixel and the fourth pixel have the same color but the first gray level, the second gray level and the fourth gray level are different from each other, the fourth pixel is operated at a fourth frequency, and the first frequency, the second frequency, and the fourth frequency are also different from each other.

8. The driving method according to claim 1, wherein the step of determining the first frequency and the second frequency according to the first gray level and the second gray level further comprises:
generating an ambient light sensing signal through an ambient light sensor; and
adjusting the first frequency or the second frequency according to the ambient light sensing signal.

9. The driving method according to claim 8, wherein the step of adjusting the first frequency or the second frequency according to the ambient light sensing signal further comprises:
obtaining a first ambient light brightness and a second ambient light brightness in sequence according to the ambient light sensing signal,
wherein when the second ambient light brightness is greater than the first ambient light brightness, the first frequency or the second frequency is decreased.

10. The driving method according to claim 1, wherein each of the pixels comprises a light-emitting diode.
